(19) United States
(12) Patent Application Publication
(10) Pub. No.: US 2011/0167896 A1
(43) Pub. Date: Jul. 14, 2011

(54) ESTIMATION OF RESERVOIR PERMEABILITY

(75) Inventors: John Erik Hershey, Ballston Lake, NY (US); Mark Lewis Grabb, Burnt Hills, NY (US); Andrew James Caruso, Schenectady, NY (US)

(73) Assignee: GENERAL ELECTRIC COMPANY, SCHENECTADY, NY (US)

(21) Appl. No.: 12/685,324

(22) Filed: Jan. 11, 2010

(51) Int. Cl. G01N 15/08

(52) U.S. Cl. 73/38

(57) ABSTRACT

A method for determining the permeability of a petroliferous reservoir comprising injecting a tagged organic molecule into the reservoir at a first location, and detecting a signal associated with tagged organic molecule at a second location in the reservoir, wherein the tagged organic molecule comprises a radionuclide having a half-life of less than a month. In certain embodiments, the tagged organic molecule comprises a radionuclide selected from the group consisting of iodine-131 and fluorine-18.

### BACKGROUND OF THE INVENTION

The embodiments disclosed herein relate generally to estimation of permeability, and more particularly to estimation of permeability of a petroliferous reservoir.

Permeability is the facility with which a rock can conduct fluids and is usually measured in darcies or millidarcies. One darcy represents the permeability of a 1 centimeter thick rock sample that allows a cubic centimeter of fluid of viscosity unit centipoise to pass through an area of a square centimeter in a second under a differential pressure of unit atmosphere. A very important associated descriptor is porosity. Porosity is defined as the fraction of the volume of a rock sample which represents void space within the rock sample. Porosity is typically reported as a fraction ranging from 0 to 1, or a percentage ranging from 0 percent to 100 percent.

The rock present in a petroliferous reservoir may be considered as composed of solid grains with open volumes or pores between the grains. The number of pores, their relative sizes and positions are factors which determine the porosity of the rock and also the permeability of the rock. It may be advantageous to measure or to estimate both the permeability and the porosity of the rock phase of an oil reservoir as a means of predicting with greater certainty the overall production potential of an oil reservoir. This knowledge is also valuable in projecting the behavior of the reservoir when it is subjected to enhanced recovery techniques with a two-phase displacement of the oil in the reservoir by water injection. In addition, the production characteristics of an oil reservoir may be affected by a number of factors in addition to porosity and permeability, for example; pressure and characteristics such as relative permeability to water, oil, and gas; reservoir dimensions, reservoir water saturation, capillary pressure and capillary pressure functions.

It is well known that the permeability and porosity characteristics of the petroliferous zones within an oil field are not necessarily constant across the field. For example, the permeability of constituent petroliferous zones comprising a given oil field may vary by several orders of magnitude over the field. Simple models at times are unable to produce useful information about field performance because the permeability and porosity characteristics of the petroliferous zones may not remain homogeneous across the field or portion of the field being modeled.

For example, consider the Saudi Arabian Ghawar oil field. The Ghawar oil field is the world's largest conventional oil field. It was discovered in 1948 and production began in 1951. At its peak, the field produced 5.7 million barrels a day. The variation in porosity and average permeability of the oil field at different locations over a range of about 10 miles is known in the art. The average porosity known for the field appears to vary in a range of from about 14 percent to about 19 percent and the average permeability appears to vary in a range of from about 52 milliDarcies to about 639 milliDarcies. The Haradh portion of the field is known as having an average porosity of 14 percent and an average permeability of 52 milliDarcies. The Hawiyah portion of the field is known as having an average porosity of 17 percent and an average permeability of 68 milliDarcies. The Uthmaniyah portion of the field is known as having an average porosity of 18 percent and average permeability of 220 milliDarcies. The Ain Dar portion of the field is known as having an average porosity of 19 percent and an average permeability 617 milliDarcies. The Shedgum portion of the field is known as having an average porosity of 19 percent and an average permeability of 639 milliDarcies.

Direct measurement of the permeability and porosity of core samples removed from a petroliferous reservoir may be made and such data can be of value. Sometimes, however, such core samples are not available and, even when available, uncertainties remain with respect to how well the core samples represent the properties of reservoir as a whole, as well as possible changes wrought by the act of coring itself and subsequent sample handling.

Various methods have been developed to attempt to estimate the permeability of a petroliferous reservoir. One method for determining the permeability of a petroliferous reservoir includes using a neutron decay logging procedure. A first aqueous liquid having a known neutron-capture cross-section is injected into the petroliferous reservoir until the water saturation of the petroliferous reservoir of interest is substantially 100 percent. Following the injection of the first aqueous liquid, a second viscous liquid having a known neutron-capture cross-section which is different from the neutron-capture cross section of the first aqueous liquid is injected into the reservoir at a low pressure. After a period of time, the concentration of the viscous liquid is measured using a neutron decay logging procedure. The injection of the viscous liquid is repeated using a higher pressure and the concentration of viscous liquid is again measured. The injection pressure is increased in discrete steps and the concentration measured for each step until the fracturing pressure of the petroliferous reservoir is approached. The concentration of the viscous liquid versus injection pressure is plotted and used to determine the permeability of the petroliferous rock. However, as described, the procedure is relatively complex, may be time consuming, and may involve the injection of relatively large volumes of multiple exogenous liquids into the reservoir.

Another method for estimating reservoir permeability involves a pressure build-up analysis in which data is collected by measurements of the bottom-hole pressure in a well that has been shut-in after a productive flow period. While production of the well is stopped the bottom-hole pressure build-up over time of the well is recorded. A profile of pressure against time may be created and used together with mathematical reservoir models to assess the extent and characteristics of the reservoir and the near well-bore area. As noted, however, to obtain such data, production from the well must generally be stopped for a significant length of time, which may be undesirable due to the associated expenses of stopping production from a well.

Another method for estimating reservoir characteristics uses production history matching process in which parameters of a reservoir model are varied until the model most closely resembles the past production history of the reservoir. A related method utilizes matching treating pressures during fracturing treatment. When utilizing these matching methods, the accuracy of the matching depends, inter alia, on the quality of the reservoir model and the quality and quantity of pressure and production data. Once a model has been matched, it may be used to simulate future reservoir behavior. A disadvantage associated with these methods, however, is that several different possible structures of a fracture or characteristics of a petroliferous reservoir may yield the same result. That is, there are many possible solutions, or sets of parameter values, that can likely produce a possible match unless further constraining information is obtained.

Another method includes the repeated application of an alternating current magnetic field to the petroliferous rock adjacent to a borehole. This results in a repetitive excitation-relaxation process of the nucleons present within an “excitation zone” adjacent to the borehole. The technique, referred to as paramagnetic logging may be used in open holes and within cased well bores. In a limited zone relatively close to the borehole, paramagnetic logging may be used to estimate the amount of oil, the amount of water, the total fluid volume, the viscosity of oil present, oil saturation and water saturation factors, permeability, positions of vertical oil and water boundaries adjacent to the borehole, and the locations of lateral discontinuities of the oil bearing formation. As noted, however, the technique is sensitive to such parameters in regions only relatively close to the borehole.

Another method includes in situ analysis of a petroliferous rock containing fluid within the rock interstices. An excitation device is provided for imparting motion to the fluid relative to the rock and the magnetic fields created by the relative motion of the fluid in the rock formation are measured, and the permeability of the rock formation is estimated. Nuclear magnetic resonance techniques and electron paramagnetic resonance techniques have also been employed as a means of estimating the permeability.

Despite the number and variety of techniques currently available, there remains a need for simple techniques for in situ measurements allowing reliable estimation of the permeability characteristics of a petroliferous reservoir.

### BRIEF DESCRIPTION OF THE INVENTION

In one embodiment, a method for determining the permeability of a petroliferous reservoir comprises injecting a tagged organic molecule into the reservoir at a first location, and detecting a signal associated with tagged organic molecule at a second location in the reservoir, wherein the tagged organic molecule comprises a radionuclide having a half-life of less than a month.

In another embodiment, a method for determining the permeability of a petroliferous reservoir comprises injecting a tagged organic molecule into the reservoir at a first location, and detecting a signal associated with tagged organic molecule at a second location in the reservoir, and wherein the tagged organic molecule comprises a radionuclide selected from the group consisting of iodine-131 and fluorine-18.

In yet another embodiment, a method for determining the permeability of a crude oil reservoir comprises injecting 1-(¹³¹I)iodooctadecane into the reservoir at a first subsurface location as a solution in crude oil, and detecting a signal associated with 1-(¹³¹I)iodooctadecane at a second subsurface location in the reservoir.

In still yet another embodiment, a method for determining the permeability of a crude oil reservoir comprises injecting 1-(¹⁸F)fluoroctadecane into the reservoir at a first subsurface location as a solution in crude oil, and detecting a signal associated with 1-(¹⁸F)fluoroctadecane at a second subsurface location in the reservoir.

Technical effects of the invention include a simplified and robust method of the estimation of the permeability of a petroliferous reservoir using in situ measurements of reservoir characteristics related to reservoir permeability and reservoir production potential. The method provided by the present invention has as an important salutary feature, the use of relatively minute amounts of a tagged organic molecule comprising a radionuclide having a relatively short half-life (less than a month) thereby eliminating long-term contamination of the petroliferous reservoir. The method further provides flexibility and is adaptable for use in the estimation of permeability and other characteristics in a wide variety of petroliferous reservoir types. This disclosure provides selected examples of suitable tagged organic molecules for use in the practice of the present invention, but one skilled in the art and having the benefit of this disclosure, will appreciate that a very wide variety tagged organic molecules comprising a radionuclide having a half-life of less than a month may be employed according to the method provided by the present invention.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an oil field with a plurality of boreholes; and

FIG. 2 is a diagrammatical representation of a method of estimating permeability in accordance with an embodiment of the present invention.

### DETAILED DESCRIPTION OF THE INVENTION

One or more specific embodiments of the present invention are described herein. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a”, “an” and “the” are intended to mean that there are one or more of the elements present. The terms “comprising,” “including,” and “having” are intended to be inclusive and mean that there may be additional elements other than the listed elements. Any examples of operating parameters and/or environmental conditions given are not intended to be exclusive of other parameters/conditions in descriptions of the disclosed embodiments.

As used herein, the phrase “tagged organic molecule” refers to an organic molecule comprising one or more radionuclides, and embraces both low molecular weight molecules and high molecular weight organic molecules.

Embodiments of the invention described herein address the noted shortcomings of state of the art methods for estimation of characteristics related to permeability in petroliferous reservoirs. In particular, the method of the present invention provides improved flexibility for ascertaining in situ characteristics related to permeability and porosity of a petroliferous reservoir. In one embodiment, these in situ measurements may be made at various locations within a borehole, for example, a production borehole or a sensing borehole. In one embodiment, the tagged organic molecule is injected into a petroliferous reservoir from one location in a borehole and thereafter, a signal associated with the tagged organic molecule within the petroliferous reservoir is detected at a second location in the borehole. The time which elapses between the injection of the tagged organic molecule and the detection of a signal associated with said tagged organic molecule, the magnitude and nature of the detected signal may be used severally or collectively to estimate one or more permeability characteristics of the petroliferous reservoir. It is believed that the present invention offers opportunities for greater reliability and cost savings relative to methods known in the art in estimating characteristics related to reservoir permeability.

As noted, in one embodiment, a method for determining the permeability of a petroliferous reservoir comprises injecting a tagged organic molecule into the reservoir at a first location; and detecting a signal associated with tagged organic molecule at a second location in the reservoir; wherein the tagged organic molecule comprises a radionuclide having a half-life of less than a month. In one embodiment, the petroliferous reservoir may be a marine subsurface rock formation beneath the sea floor. In an alternate embodiment, the petroliferous reservoir may be a “dry-land” subsurface rock formation.

In various embodiments the tagged organic molecule comprises a radionuclide having a half-life of less than a month. Suitable radionuclides include iodine 131, bromine 82, fluorine 18, carbon 11, and nitrogen 13 each of which radionuclides has a half-life of less than 1 month. In an alternate embodiment, the tagged organic molecule comprises a radionuclide having a half-life of less than 1 week. In yet another embodiment, the tagged organic molecule comprises a radionuclide having a half-life of less than 1 day. In yet still another embodiment, the tagged organic molecule comprises a radionuclide selected from the group consisting of iodine 131 and fluorine 18.

In one embodiment, the tagged organic molecule comprises 1-(¹³¹I)iodooctadecane. Those of ordinary skill in the art will appreciate that tagged organic molecules such as 1-(¹³¹I)iodooctadecane may be prepared using standard radiochemical synthetic methodology such as by reaction 1-octadecanol tosylate with readily available sodium or potassium (131)iodide in a polar solvent such as acetonitrile at a temperature in a range from about ambient temperature to the reflux temperature of the solvent under ambient conditions. Similarly, acetone may be used as the reaction solvent. Catalysts such as crown ethers may be included in the reaction mixture to accelerate the rate of conversion of the starting tosylate to the product tagged organic molecule comprising iodine 131. The reaction may be carried out using a molar excess of the starting tosylate in order to convert the maximum amount of the starting iodide into the product. Following the reaction the product tagged organic molecule may be separated from any residual inorganic iodide by for example, passage down a column of silica gel. For the purposes of the present invention, it is generally unnecessary to separate any remaining tosylate from the product since in general the presence of this starting material in the sample of the tagged organic molecule injected into the reservoir is not anticipated to interfere with the either the injection step, the detection step or the movement of the tagged organic molecule within the reservoir.

In another embodiment, the tagged molecule may comprise 1-(¹⁸F)fluoroctadecane. Those of ordinary skill in the art will appreciate that 1-(¹⁸F)fluoroctadecane may be prepared in a manner analogous to the preparation of 1-(¹³¹I)iodooctadecane except that a source of (¹⁸F)fluoride is employed instead of sodium or potassium (¹³¹I)iodide. Commercial sources of (¹⁸F)fluoride are widely available and techniques for carrying out a nucleophilic substitution reaction SN2 using commercially available (¹⁸F)fluoride are well known. Following the reaction the product tagged organic molecule comprising (¹⁸F)fluorine may be separated from any residual inorganic fluoride by for example, passage down a column of silica gel or other expedient used for such purposes and known in the art.

As noted, the method of the present invention includes detection of a signal associated with the tagged organic molecule at a second location within the reservoir. Thus, the tagged organic molecule is injected into the reservoir at a first location and traverses a portion of the reservoir under the influence of an applied force, for example pressure in the form a pressurized liquid or gas which forces the tagged organic molecule into the reservoir. In one embodiment, the tagged organic molecule is injected into the reservoir and thereafter is eluted with a solvent thereby distributing the tagged organic molecule as a moving front within the reservoir. A detector located at a second location within the reservoir detects a signal associated with the tagged organic molecule as the moving front approaches the location of the detector. Those of ordinary skill in the art will appreciate that the time to the onset of detection at the second location and the magnitude of the applied force may together be used to assess the permeability characteristics of the reservoir.

In one embodiment, the signal associated with tagged organic molecule detected at a second location in the reservoir is a gamma ray. In an alternate embodiment, the signal associated with tagged organic molecule detected at a second location in the reservoir is a beta particle. In yet another embodiment, the signal associated with tagged organic molecule detected at a second location in the reservoir is a photon arising from a positron annihilation event.

The amount of tagged organic molecule need only be sufficient to be detected at the second location within the reservoir and the actual mass of tagged organic molecule injected is anticipated to be on the order of less than a milligram. In one embodiment, the amount of tagged organic molecule injected into the reservoir corresponds to less than about 200 milliCuries of radioactivity. In another embodiment, the tagged organic molecule corresponds to less than about 180 milliCuries of radioactivity. In yet another embodiment, the tagged organic molecule corresponds to less than about 150 milliCuries of radioactivity.

In one embodiment, the method comprises injecting a tagged organic molecule into the reservoir at a first location as a solution in contact with a surface of the reservoir and applying a force to the solution to drive it into the reservoir at the first location. In various embodiments, the solution comprising the tagged organic molecule may comprise the tagged organic molecule and a solvent that is compatible with the tagged organic molecule. In one embodiment, the solvent is such that the tagged organic molecule dissolves completely in the solvent and forms a homogenous solution. In another embodiment, the solvent may function as a carrier and the tagged organic molecule may be finely dispersed in the solvent. In certain other embodiments, the solvent is a neutral solvent that does not react with the tagged organic molecule. Suitable examples of solvents include hydrocarbon solvents such as decane, hexadecane, octadecane, crude oil, and refined oil; ethers such as diphenyl ether, anisole, 4-hexylanisole, ethylene glycol dimethyl ether, and ethers of polyethylene glycol; and esters such as ethyl acetate, methyl benzoate, and butyrolactone. The solvent may be selected such that it provides for both ease and safety of handling and does not result in undue contamination of the reservoir.

The amount of solvent employed may vary with parameters such as the distance between the second location at which a signal associated with tagged organic molecule is detected and the first location, the permeability of the reservoir between these locations, and the presence of inhomogeneities such as fissures and channels in the region of the reservoir in which the measurements are conducted. In one embodiment, the quantity of the solvent employed is in a range of about 10 milliliters to about 1000 liters. In another embodiment, the quantity of the solvent employed is in a range of about 100 milliliters to about 100 liters. In yet another embodiment, the quantity of the solvent employed is in a range of about 1 liter units to about 10 liters.

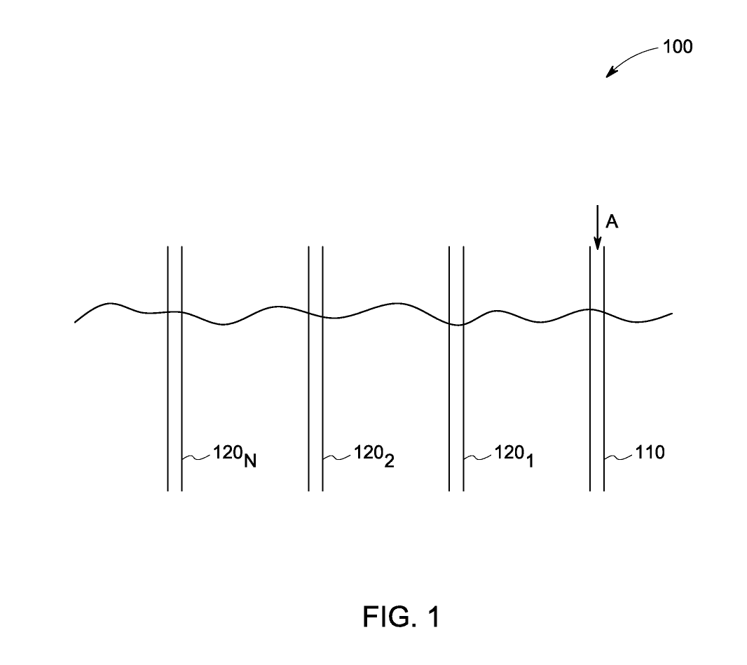

FIG. 1 illustrates an oil field with N+1 boreholes 100. In one aspect, the method of the present invention may be used to determine whether or not a minimum pore throat radius exists in the petroliferous reservoir between the well hole serving as the injection point A 110 and the sampling wells W1, W2, . . . , WN 120₁-120_{N}.

The particular pore throat size characteristics of a reservoir may be probed by varying the size and structure of the tagged organic molecule employed and injected into the reservoir injection point A 110 and measuring the transport times and efficiencies associated with the migration of the tagged organic molecule from the first location within the reservoir to positions within the reservoir where signals associated with the tagged organic molecule may be detected at second locations within the reservoir for examples sampling wells W1, W2, . . . , WN 120₁-120_{N}. If the size and structure of the tagged organic molecule exceed the capability of the pores within the reservoir to allow migration of the tagged organic molecule, the particular pore throat size distribution of the reservoir can be estimated from the size of the particular tagged organic molecule at which the onset of the inhibition of migration is observed. Where a particular tagged organic molecule is not able to migrate from the first location to a point within the reservoir wherein a signal associated with the tagged organic molecule may be detected at the second location, and tagged organic molecules of smaller dimensions have successfully so migrated, then it may be concluded that the pore throat radius in the region between the injection point A 110 and the particular sampling well is smaller than the non-migrating tagged organic molecule.

The structure of the tagged organic molecule used to probe reservoir pore throat size distributions may be highly varied and techniques for producing both branched variants of tagged organic molecules such as 1-(¹³¹I)iodooctadecane are well known to the art. In addition, it is possible to prepare oligomeric and polymeric tagged organic molecules having almost any size. For example, polystyrene comprising either iodine 131 or bromine 82 are known in the art and those of ordinary skill in the art may employ art recognized techniques to produce a wide variety of low and high molecular weight polystyrenes having highly varied dimensions. As noted, at least one of the tagged organic molecules tested should be easily detectable at the sampling wells W1, W2, . . . , WN 120₁-120_{N}. Again, it is emphasized that because the probe molecules (the tagged organic molecules) comprise one or more radionuclides, vanishingly small amounts of tagged organic molecule may be employed and the thus the technique is not expected to negatively affect the later production characteristics of the reservoir.

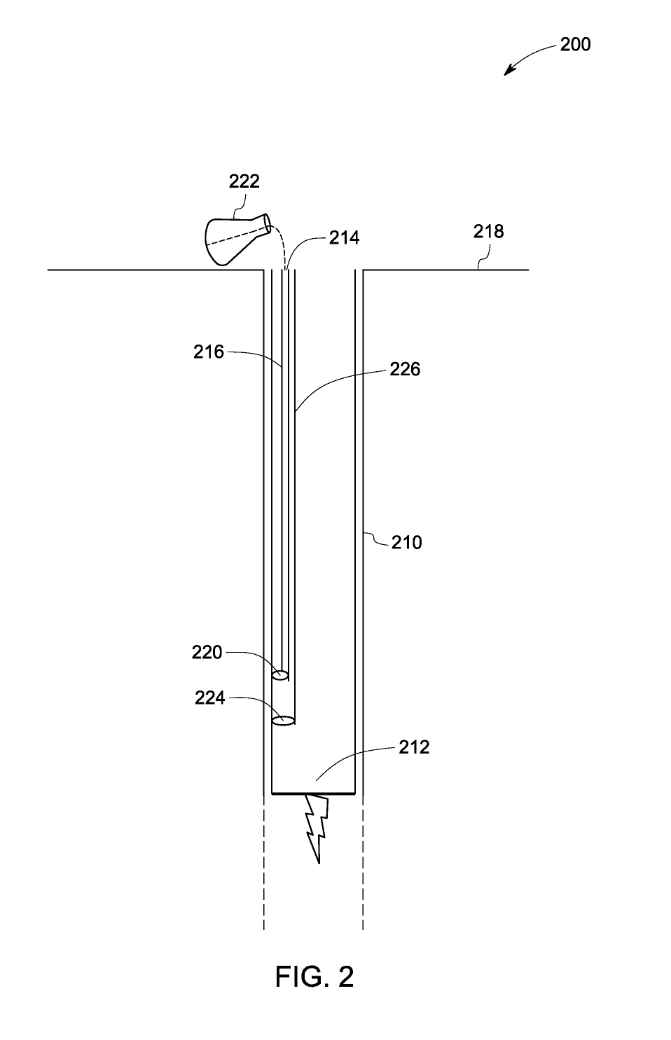

Referring to FIG. 2, a diagrammatical representation 200 of a method of estimating permeability in accordance with an embodiment of the present invention is provided. As shown in the figure, a well hole 210 has a drill bit assembly 212 that comprises an effusion port 214. A transportation tube 216 is lowered though the well hole 210. The transportation tube 216 connects the effusion port 214 on a surface portion 218 of the well hole 210 to a detection port 220 located within a distance inside the well hole 210 in the path of the drill bit assembly 212. A solution comprising a permeability estimating tagged organic molecule 222 is introduced into the transportation tube 216 at the effusion port 214 upon a command conveyed from the surface by a wide variety of means including electrical, optical, acoustic, seismic, or magnetic means. As used herein the “effusion port” 214 is a place where the tagged organic molecule is injected and the “detection port” 220 is the place where the tagged organic molecule is detected. The solution 222 may be forced out of the detection port 220 by applying a pressure using a device (not shown in figure). The solution 222 then travels the path from the effusion port 214 to the detection port 220. A radiation detector 224 may be positioned near the detection port 220 in the path of the drill bit assembly 212, such that the radiation detector 224 is capable of detecting a signal associated with the tagged organic molecule present in the solution 222. The radiation detector 224 is connected to an analytical equipment (not shown in figure) via a conductor 226. Under the applied force the tagged organic molecule arrives at locations in the reservoir where signals associated with the tagged organic molecule can be detected at the detection port 220. The time between injection and detection and the applied force are noted and may be used to estimate the permeability of the reservoir.

In FIG. 2 the effusion port 214 is depicted as above the detection port 220. The relative positions of the ports may be reversed without affecting the method. The separation between the effusion port 214 and the detection port 220 equipped with the radiation detector 224 may be measured in feet. In one embodiment, the distance between the effusion port and the detection port is of the order of ten feet. In another embodiment the distance between the effusion port and the detection port is of the order of one hundred feet. In various embodiments, the distance between the effusion port and the detection port is of the order of ten feet and may range from a few feet to several hundred feet. In one embodiment, the tagged organic molecule is introduced into the reservoir through the effusion port 214 from a chamber located within the drill stem and may be released upon a command from the surface. In FIG. 2 the radiation detector is linked to the surface via the conductor 226 for reporting purposes. The data collected at the detector may be conveyed to the surface by a wide variety of means including electrical, optical, acoustic, seismic, or magnetic means

In certain embodiments, the solution 222 may comprise plurality of tagged organic molecules having different molecular dimensions. In certain embodiments, the tagged organic molecules may be differentiated by the identity of the radionuclide present in the different tagged organic molecules, for example a mixture comprising a first tagged organic molecule comprising fluorine-18 and having a first molecular size and a second tagged organic molecule comprising iodine-131 and having a second larger molecular size. The detector 224 employed may distinguish between signals associated with the first tagged organic molecule and signals associated with the second tagged organic molecule thereby allowing single test pore size estimation tests. For example, where the first tagged organic molecule is detected and the second tagged organic molecule is not detected it may be concluded that the diameter of the pore throat of the petroliferous reservoir in the area between the effusion port 214 and the detection port 220 is less than the dimensions of the second tagged organic molecule.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for determining the permeability of a petroliferous reservoir comprising:
injecting a tagged organic molecule into the reservoir at a first location; and
detecting a signal associated with tagged organic molecule at a second location in the reservoir;
wherein the tagged organic molecule comprises a radionuclide having a half-life of less than a month.

2. The method of claim 1, comprising injecting a tagged organic molecule into the reservoir at a first location as a solution in contact with a surface of the reservoir and applying a force to the solution to drive it into the reservoir at the first location.

3. The method of claim 1, wherein the tagged organic molecule comprises 1-(¹³¹I)iodooctadecane.

4. The method of claim 1, wherein the tagged organic molecule comprises 1-(¹⁸F)fluoroctadecane.

5. The method of claim 1, wherein said detecting comprises the detection of a gamma ray.

6. The method of claim 1, wherein said detecting comprises the detection of a beta particle.

7. The method of claim 1, wherein said detecting comprises the detection of a photon arising from a positron annihilation event.

8. The method of claim 1, wherein the half-life is less than 1 week.

9. The method of claim 1, wherein the half-life is less than 1 day.

10. The method of claim 1, wherein the tagged organic molecule corresponds to a less than about 200 milliCuries of radioactivity providing a means for detecting the tagged molecule; wherein the means for detecting the tagged molecule is located in the reservoir.

11. A method for determining the permeability of a petroliferous reservoir comprising:
injecting a tagged organic molecule into the reservoir at a first location; and
detecting a signal associated with tagged organic molecule at a second location in the reservoir;
wherein the tagged organic molecule comprises a radionuclide selected from the group consisting of iodine 131 and fluorine 18.

12. The method of claim 11, comprising injecting a tagged organic molecule into the reservoir at a first location as a solution in contact with a surface of the reservoir and applying a force to the solution to drive it into the reservoir at the first location.

13. The method of claim 11, wherein the tagged organic molecule comprises 1-(¹³¹I)iodooctadecane.

14. The method of claim 11, wherein the tagged organic molecule comprises 1-(¹⁸F)fluoroctadecane.

15. The method of claim 11, wherein said detecting comprises the detection of a gamma ray.

16. The method of claim 11, wherein said detecting comprises the detection of a beta particle.

17. The method of claim 11, wherein said detecting comprises the detection of a photon arising from a positron annihilation event.

18. A method for determining the permeability of a crude oil reservoir comprising:
injecting 1-(¹³¹I)iodooctadecane into the reservoir at a first subsurface location as a solution in crude oil, and
detecting a signal associated with 1-(¹³¹I)iodooctadecane at a second subsurface location in the reservoir.

19. A method for determining the permeability of a crude oil reservoir comprising:
injecting 1-(¹⁸F)fluoroctadecane into the reservoir at a first subsurface location as a solution in crude oil, and
detecting a signal associated with 1-(¹⁸F)fluoroctadecane at a second subsurface location in the reservoir.
